(19) United States
(12) Patent Application Publication
(10) Pub. No.: US 2011/0315848 A1
(43) Pub. Date: Dec. 29, 2011

(54) Number Plate Holder

(76) Inventors: Rainer Risse, Pattensen-Reden (DE); Udo Ronnenberg, Wedemark (DE); Axel Stender, Hameln (DE)

(21) Appl. No.: 13/128,772

(22) PCT Filed: Aug. 8, 2009
(86) PCT No.: PCT/EP09/05780

§ 371 Date: Jul. 5, 2011

(30) Foreign Application Priority Data
Nov. 13, 2008 (DE) 10-2008-057-164.4

(51) Int. Cl. B60R 13/10

(52) U.S. Cl. 248/475.1

(57) ABSTRACT

The invention relates to a number plate holder (1) for holding a number plate (2) of a vehicle, wherein the number plate holder (1) has at least one distance sensor (5).

The invention generally relates to embodiments of a license plate holder for holding a license plate of a vehicle.

Vehicles are increasingly being equipped with distance sensors for sensing objects in front of, next to or behind the vehicle. The distance sensors serve to assist the driver, in particular during rearward travel or parking the vehicle.

It is known to mount the distance sensors in a separate holder at the rear of the vehicle. Furthermore, DE 198 31 262 A1 discloses arranging the distance sensors within impact buffers of a trailer vehicle. These previously known embodiments have the disadvantage that they entail increased installation complexity during production at the motor vehicle manufacturers' premises since either separate holders have to be mounted or connected by cable or impact buffers with cables have to be provided.

It is an object of the present invention to reduce the complexity involved in mounting the distance sensors.

The invention solves this object by means of the features as specified in the independent claims. The dependent claims contain expedient embodiments.

The invention provides a license plate holder for holding a license plate or license tag of a vehicle, wherein the license plate holder has at least one distance sensor. As a result of the integration of the distance sensor in the license plate holder, the complexity involved in the installation is reduced since no additional holder is required for installing the distance sensor. Furthermore, there is no need for any additional cabling in the vehicle since in any case the license plate holder has to be connected to a cable to form electrical contact in order to illuminate the license plate. The invention therefore contributes to reducing the installation time and costs for the vehicle manufacturer. Furthermore, by eliminating the separate holder, savings in material costs is additionally obtained. Distance sensors within the scope of the inventive embodiments are to be understood as being sensors for sensing persons or objects behind, in front of, next to, underneath or above the vehicle or sensors for determining the distance between the vehicle and objects or persons. These sensors can be embodied, for example, as ultrasonic sensors or radar sensors.

Advantageous embodiments of the invention emerge from the subclaims and from the exemplary embodiments which are explained in more detail with reference to the appended drawings, in which:

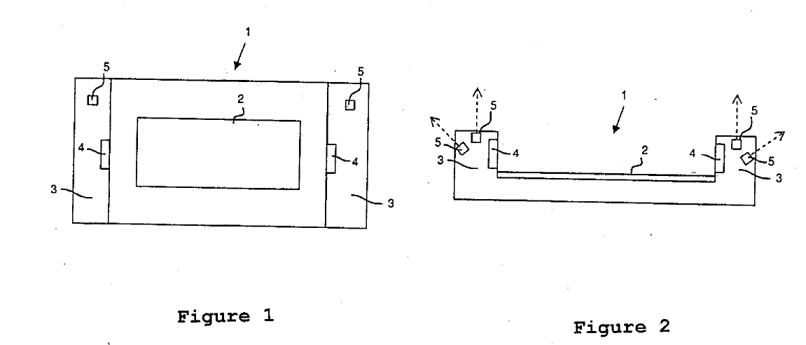

FIG. 1 is a schematic view of a license plate holder with distance sensors from the front,

FIG. 2 is a schematic view of a license plate holder with distance sensors from above,

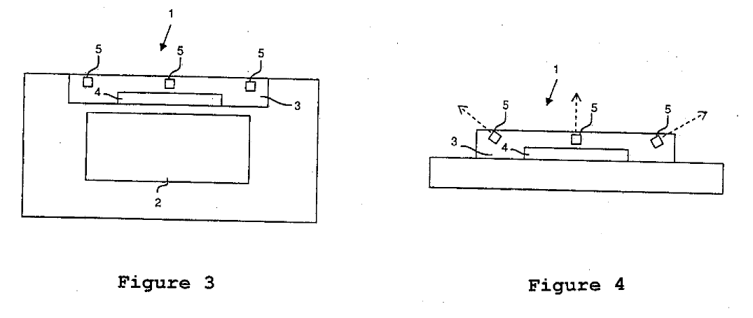

FIG. 3 is a schematic view of a license plate holder with distance sensors from the front,

FIG. 4 is a schematic view of a license plate holder with distance sensors from above, and

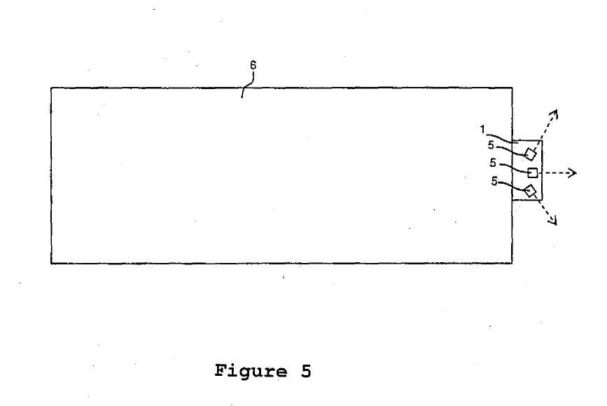

FIG. 5 is a schematic view of a trailer vehicle with a license plate holder with distance sensors from above.

FIG. 1 is a schematic view of a license plate holder 1 for holding a license plate 2 or license tag of a vehicle viewed from the front. The license plate 2 is arranged centrally in the license plate holder 1. To the left and right next to the license plate 2 there are lighting elements 3. The lighting elements 3 are to be understood as the elements of the license plate holder 1 that have lighting means 4 for illuminating the license plate 2. These elements may be, for example, depressions or bulges in the license plate holder 1 that are provided with lighting means 4.

In addition to the lighting means 4, each of the lighting elements 3 has a distance sensor 5. The inventive integration of the distance sensors 5 in the license plate holder 1 provides the following advantages. On the one hand, the complexity involved in installation is reduced since no additional holder is required for installing the distance sensor 5. Furthermore, no additional cabling is required in the vehicle since in any case the license plate holder 1 has to be connected to a cable for forming electrical contact with the lighting means 4 in order to illuminate the license plate 2. The invention therefore contributes to reducing the installation time and costs for the vehicle manufacturer. Furthermore, the elimination of a separate holder additionally allows savings in terms of materials costs.

FIG. 2 is a schematic view of a license plate 1 with integrated distance sensors 5 viewed from above. In this embodiment, the license plate holder 1 has two lighting elements 3 arranged to the right and left next to the license plate 2 each of which includes two distance sensors 5. The two distance sensors 5 of a lighting element 3 have an orientation in the rearward direction (or in the forward direction depending on the way in which the license plate holder 1 is attached to the vehicle) and different main irradiation directions obliquely to the side. The main irradiation direction of the distance sensors 5 is respectively characterized in FIG. 2 by an arrow that is represented by dashed lines. The different orientation of the distance sensors 5 ensures the most continuous possible monitoring of the space behind (and/or in front of) the vehicle.

FIG. 3 is a schematic view of a license plate holder 1 viewed from the front. In this embodiment, the license plate holder 1 has a lighting element 3 arranged above the license tag 2. In addition to the lighting means 4, the lighting element 3 has three distance sensors 5. This collection of distance sensors 5 is also referred to as a cluster. A corresponding selection of the main irradiation direction of the distance sensors 5 of the cluster ensures the most continuous possible monitoring of the space behind (and/or in front of) the vehicle.

In FIG. 4, the license plate holder 5 illustrated in FIG. 3 is shown viewed from above. The different main irradiation directions of the distance sensors 5 can be seen through the arrows illustrated by dashed lines in FIG. 4.

FIG. 5 is the schematic view of a trailer vehicle 6 viewed from above. The license plate holder 1 is arranged at the rear on the trailer vehicle 6. The license plate holder 1 has three distance sensors 5, the main irradiation directions of which are characterized by arrows that are illustrated by dashed lines. The different main irradiation directions of the distance sensors 5 ensure the most continuous possible monitoring of the space behind the trailer vehicle 6.

In a preferred embodiment of the invention, the license plate holder 1 is mounted on or at a bumper of the vehicle. A further preferred configuration provides for the license plate holder 1 to have a bushing for forming electrical contact with the distance sensors 5 and the lighting means 4.

Ultrasonic sensors, radar sensors, laser scanners or a sensor that is based on a camera can be used as distance sensors 5. In the case of ultrasonic sensors, the distance sensor 5 emits a sound signal, for example at the request of a control unit, and receives reflections of this sound signal. The distance between the distance sensor 5 and an object can be inferred in a known fashion from the difference in timing between the emission of the sound signal and the reflections.

In one embodiment of the invention, the distance sensor 5 contains electronic switching means by which digital signals that can be easily evaluated are generated.

1. A license plate holder (1) for holding a license plate (2) of a vehicle, characterized in that the license plate holder (1) has at least one distance sensor (5).

2. The license plate holder (1) as claimed in claim 1, characterized in that the license plate holder (1) has a cluster of distance sensors (5).

3. The license plate holder (1) as claimed in one of the preceding claims, characterized in that the license plate holder (1) is mounted on or at a bumper of the vehicle.

4. The license plate holder (1) as claimed in one of the preceding claims, characterized in that the distance sensor (5) is embodied as an ultrasonic sensor, radar sensor, laser scanner or as a sensor which is based on a camera.

5. The license plate holder (1) as claimed in one of the preceding claims, characterized in that the license plate holder (1) has at least one lighting element (3), wherein at least one distance sensor (5) is integrated into the lighting element (3).

6. The license plate holder (1) as claimed in claim 5, characterized by a lighting element (3) which is formed above the license plate (2).

7. The license plate holder (1) as claimed in claim 5 or 6, characterized by two lighting elements (3) which are located to the right and left next to the license plate (2).

8. The license plate holder (1) as claimed in one of the preceding claims, characterized in that the license plate holder (1) has at least one lighting means (4).

9. The license plate holder (1) as claimed in claim 8, characterized in that the license plate holder (1) has a bushing for forming electrical contact with the distance sensor (5) and the lighting means (4).

10. A towing vehicle, characterized by a license plate holder (1) as claimed in one of claims 1 to 9.

11. A trailer vehicle, characterized by a license plate holder (1) as claimed in one of claims 1 to 9.
